(19) United States
(12) Patent Application Publication
(10) Pub. No.: US 2007/0285020 A1
(43) Pub. Date: Dec. 13, 2007

(54) Current balance circuit

(75) Inventors: Guo-Fei Yao, Taoyuan Hsien (TW); Tai-Sheng Po, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/802,504

(22) Filed: May 23, 2007

(30) Foreign Application Priority Data
Jun. 8, 2006 (TW) 095120363

(51) Int. Cl. B60Q 1/02

(52) U.S. Cl. 315/82

(57) ABSTRACT

A current balance circuit is driven by a power source to balance currents flowing through a plurality of lamps. The current balance circuit includes a plurality of first balance transformers. The first balance transformers are electrically connected to the lamps respectively. The first balance transformers are connected in series.

This Non-provisional application claims priority under 35 U.S.C. §119(a) on Patent Application No(s). 095120363 filed in Taiwan, Republic of China on Jun. 8, 2006, the entire contents of which are hereby incorporated by reference.

### BACKGROUND OF THE INVENTION

1. Field of Invention

The invention relates to a current balance circuit and in particular to a current balance circuit for lamps.

2. Related Art

In recent years, the flat panel display has become increasingly popular. Liquid crystal displays (LCDs) have become the mainstream in the market. In response to increased demands on size, the number of cold cathode fluorescent lamps (CCFLs) serving as the backlight source has to be increased for providing sufficient luminance. For example, if the LCD is enlarged to 40 inches, the number of lamps may be 30 or more. However, as the number of the lamps is increased, the luminance between the lamps may become non-uniform. The prior art solves this problem by the way of impedance matching or adding a balance transformer.

Referring to FIG. 1, a conventional driving system 1 for cold cathode fluorescent lamps includes a driving circuit 11, a main transformer 12, a voltage stable capacitor 13, a plurality of adjusting capacitors 14, a plurality of cold cathode fluorescent lamps 15 and a feedback circuit 16. A power source Vin is inputted to the driving circuit 11. The main transformer 12 transforms the voltage level of the power source, which is stabilized by the voltage stable capacitor 13 to drive the cold cathode fluorescent lamps 15 to emit light. The feedback circuit 16 controls the driving circuit 11 to adjust the power source Vin supplied to the main transformer 12 according to the voltage or the current of one of the cold cathode fluorescent lamps 15 so as to adjust the currents of the cold cathode fluorescent lamps 15 to change the light luminance. In order to ensure uniform light luminance in the prior art, the cold cathode fluorescent lamps 15 have adjusting capacitors 14 to match the impedance of each cold cathode fluorescent lamp 15 so that the currents of the cold cathode fluorescent lamps 15 and their respective luminance may be uniformly outputted. However, this method has to measure the impedance of each cold cathode fluorescent lamp 15 in advance so that the adjusting capacitors 14 with the suitable capacitances can be selected to achieve the impedance matching. In addition, when the number of the lamps is increased, the required number of adjusting capacitors is increased so that the measurements of the lamps and the selections of the capacitors become ever more complicated.

FIG. 2 shows another conventional driving system 1′ for cold cathode fluorescent lamps. The difference between FIGS. 2 and 1 is that a capacitor 18 and a balance transformer 17 are electrically connected to the main transformer 12 and the cold cathode fluorescent lamps 15. The balance transformer 17 has a plurality of coils 171 which has the same number of loops and each two coils 171 are paired. Hence, the currents flowing from the coils 171 are the same. Each end of the coils 171 is electrically connected to the main transformer 12 through the capacitor 18, and another end of the coils 171 is connected to the cold cathode fluorescent lamps 15. Therefore, the currents of each cold cathode fluorescent lamp 15 are the same. Under this architecture, however, the balance transformer 17 is too large, and the number of the coils 171 of the balance transformer 17 increased with the number of the lamps. Thus, the coils 171 cannot, be easily coupled and the current balance effect is poor.

FIG. 3 shows still another conventional driving system 1″ for cold cathode fluorescent lamps. The difference between FIGS. 3 and 1 is that the driving system 1″ has a plurality of main transformers 12, and each main transformer 12 drives two cold cathode fluorescent lamps 15. The currents flowing through the two cold cathode fluorescent lamps 15 are balanced through a balance transformer 19. Consequently, it is ensured that the two cold cathode fluorescent lamps 15 are driven by the same current value to generate the same luminance of light. Thus, the impedances of the lamps can be matched according to the adjusting capacitors 14, and the currents flowing through the lamps may also be balanced according to the balance transformer. However, as the lamps increased in number, the driving system 1″ also needs more adjusting capacitors 14. Each adjusting capacitor 14 and each balance transformer 19 also need to be adjusted and corrected with a longer time period.

Thus, it is an important subject to provide a current balance circuit for cold cathode fluorescent lamps, which is capable of avoiding the above-mentioned problems and improving the above-mentioned drawbacks so that the current balance effect of the driving system for the cold cathode fluorescent lamps is enhanced, and the uniform luminance of the lamps may be ensured.

### SUMMARY OF THE INVENTION

In view of the foregoing, the invention is to provide a current balance circuit for lamps to enhance the current balance effect.

To achieve the above, the invention discloses a current balance circuit driven by a power source to balance currents of a plurality of lamps. The current balance circuit includes a plurality of first balance transformers, which is electrically connected with the lamps respectively, and connected in series.

As mentioned above, the current balance circuit according to the invention has series-connection balance transformers. Compared to the prior art, the invention enables the driving current of the lamp to flow through at least two balance transformers. Hence, the number of times of the driving current flowing through the balance transformer is increased and thus the current balance effect is enhanced.

### BRIEF DESCRIPTION OF THE DRAWINGS

The invention will become more fully understood from the detailed description given herein below illustration only, and thus is not limitative of the present invention, and wherein:

FIGS. 1 to 3 are schematic illustrations showing conventional driving systems for cold cathode fluorescent lamps;

FIGS. 4 to 5 are schematic illustrations showing a current balance circuit applied to a driving system according to a preferred embodiment of the invention;

FIGS. 6 to 8 are schematic illustrations showing another current balance circuit applied to a driving system according to the preferred embodiment of the invention; and

FIG. 9 is a schematic illustration showing still another current balance circuit applied to a driving system according to the preferred embodiment of the invention.

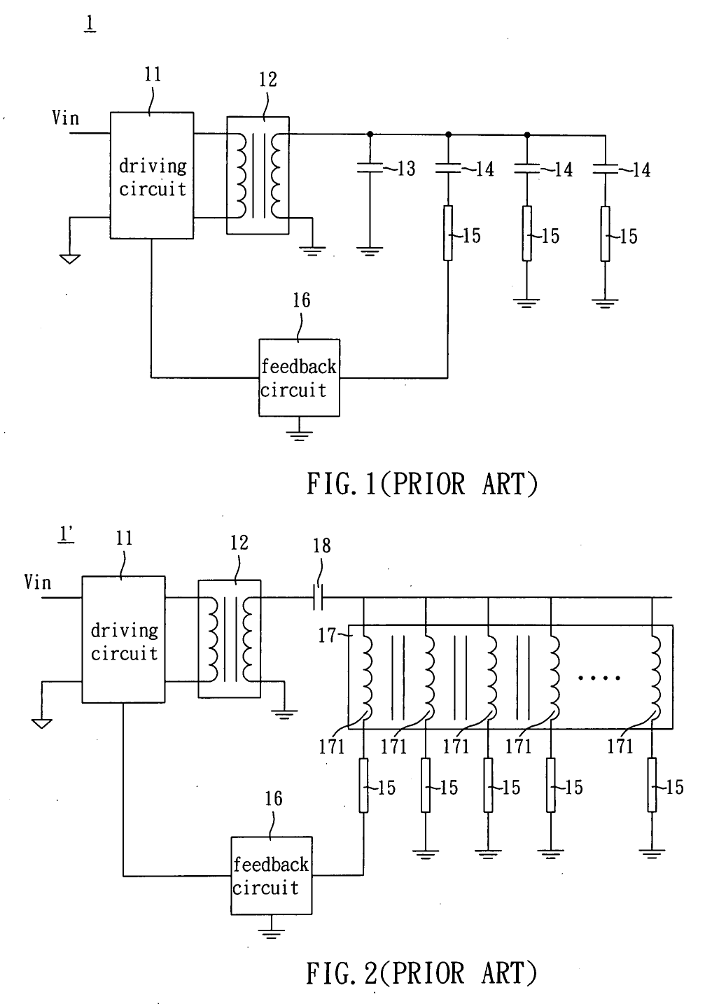

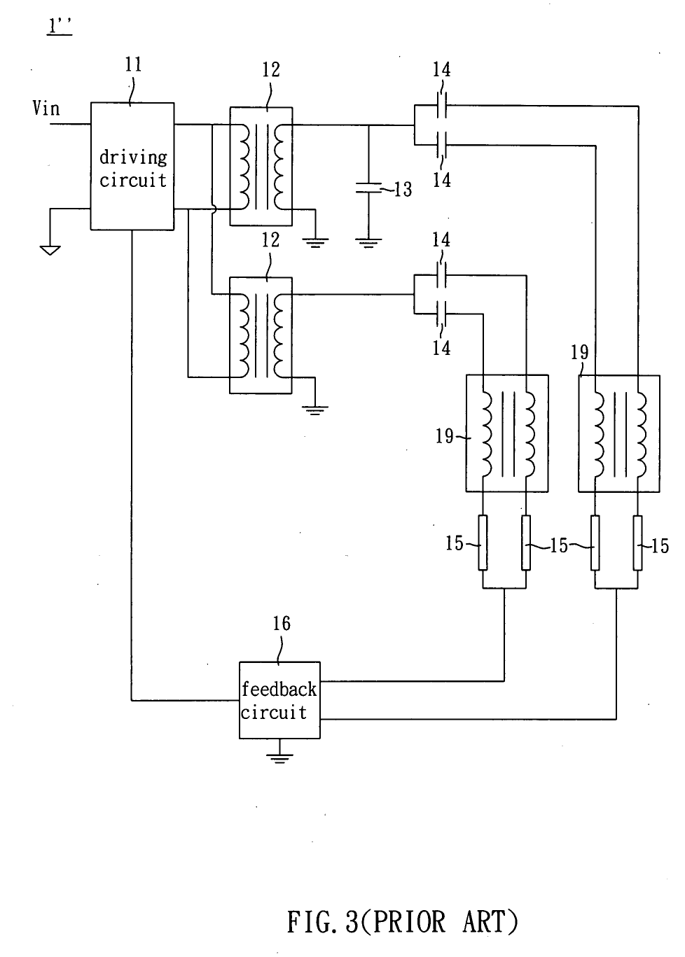

### DETAILED DESCRIPTION OF THE INVENTION

The present invention will be apparent from the following detailed description, which proceeds with reference to the accompanying drawings, wherein the same references relate to the same elements.

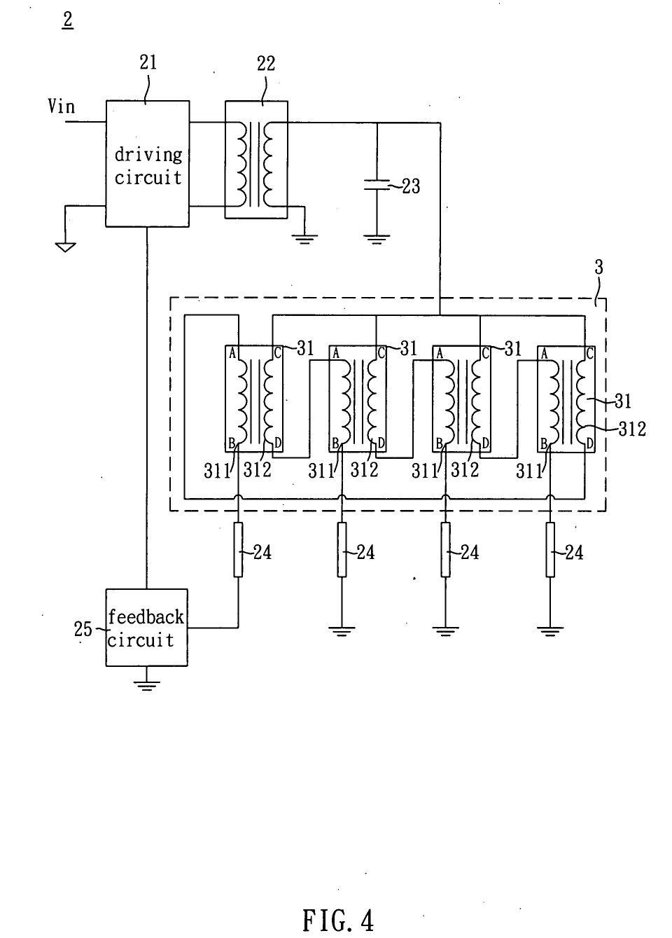

Referring to FIG. 4, a current balance circuit 3 according to the preferred embodiment of the invention is applied to a driving system 2. The driving system 2 may be applied to a backlight module and includes a driving circuit 21, at least one main transformer 22, at least one voltage stable capacitor 23, the current balance circuit 3, a plurality of lamps 24 and a feedback circuit 25. A power source Vin is inputted to the driving circuit 21. The main transformer 22 transforms the voltage level of the power source Vin, and the voltage stable capacitor 23 stabilizes the transformed voltage. Then, the current balance circuit 3 receives the stable voltage to balance the currents for driving the lamps 24. The current balance circuit 3 is electrically connected to the power source Vin through the driving circuit 21 and the main transformer 22.

The current balance circuit 3 includes a plurality of first balance transformers 31 electrically connected to the lamps 24 respectively. In addition, the first balance transformers 31 are connected in series.

Each first balance transformer 31 has a primary winding 311 and a secondary winding 312. The primary winding 311 has a first terminal A and a second terminal B. The secondary winding 312 has a third terminal C and a fourth terminal D, which is electrically connected to the first terminal A of another first balance transformer 31 in serious.

In this embodiment, the second terminals B of the first balance transformers 31 are electrically connected to the lamps 24 respectively. The third terminals C of the first balance transformers 31 are electrically connected to the main transformer 22 and the voltage stable capacitor 23. The main transformer 22 is electrically connected to the driving circuit 21.

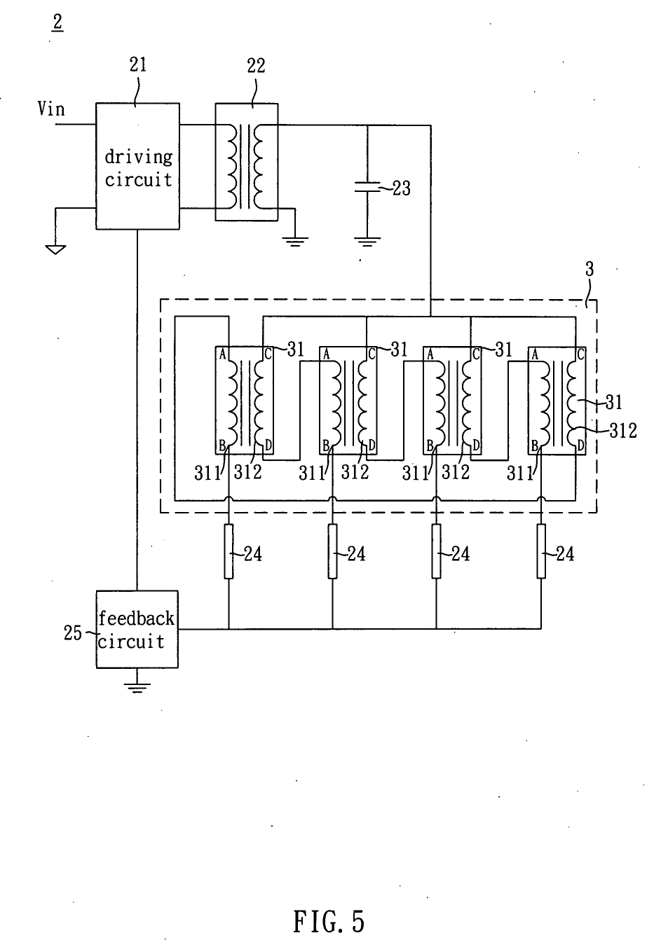

For the application of the backlight module, the lamps are cold cathode fluorescent lamps (CCFLs) 24 that are grounded. One of the lamps 24 is electrically connected to the feedback circuit 25. The feedback circuit 25 is electrically connected to the driving circuit 21 in order to control the driving circuit 21 to adjust the output voltage. On the other hand, the lamps 24 may be grounded in a manner that may be varied according to the variation of the backlight module. Also, the lamps 24 are electrically connected to the feedback circuit 25 simultaneously and grounded simultaneously as shown in FIG. 5. The feedback circuit 25 may also be electrically connected to the driving circuit 21 in order to control the driving circuit 21 for adjusting the output voltage.

Regardless of the grounding method of FIG. 4 or 5, the current of each lamp is forced through the two first balance transformers 31. Thus, the number of times of balancing the current of each lamp is increased, and the current balancing effect is thus enhanced. Therefore, the lamps driven by the uniform currents have uniform light intensity.

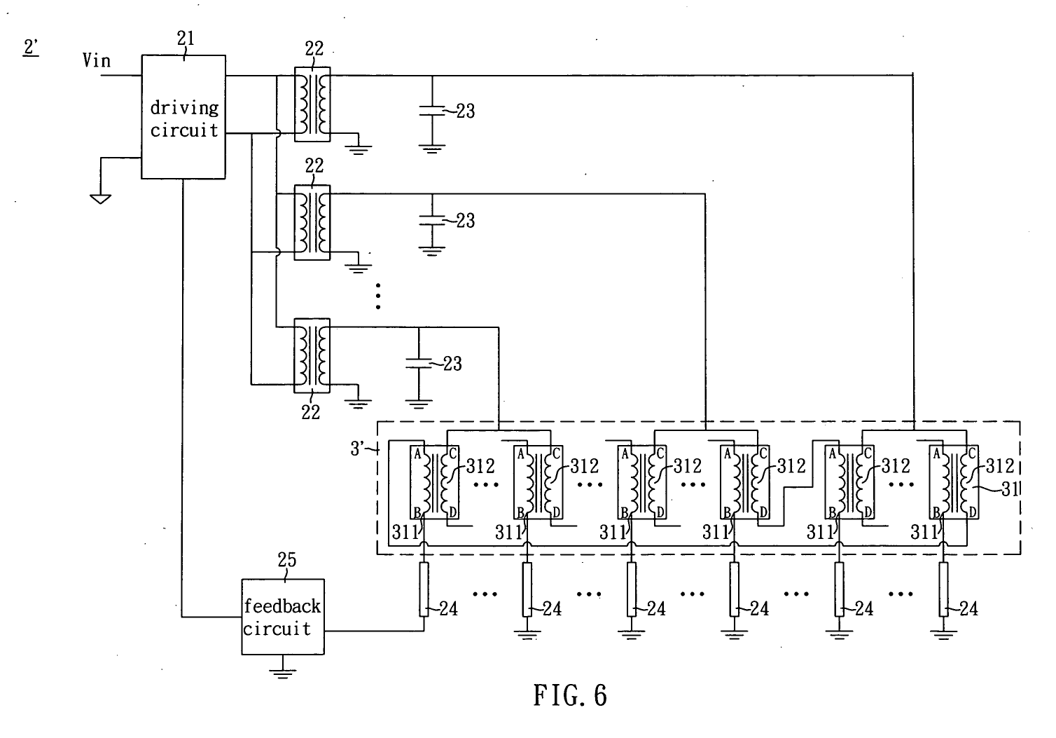

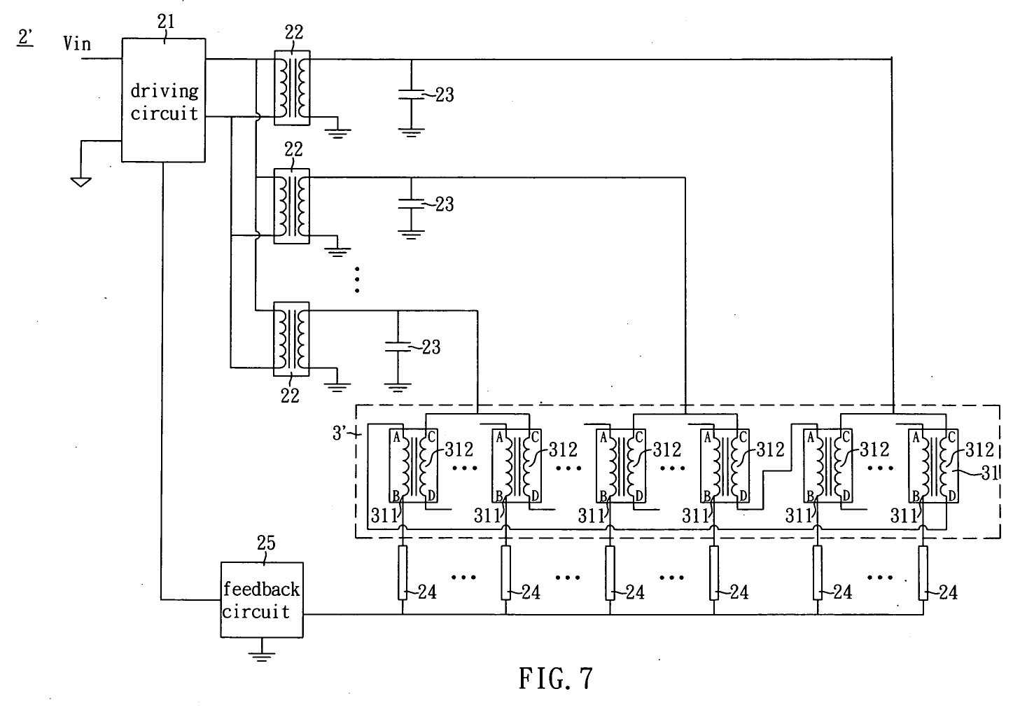

Referring to FIG. 6, another driving system 2′ includes m main transformers 22 and m voltage stable capacitors 23. Each main transformer 22 drives n lamps 24, which may be cold cathode fluorescent lamps. The current balance circuit 3′ is electrically connected to and between the main transformers 22 and the lamps 24, and the current balance circuit 3′ includes m×n first balance transformers 31 to balance the currents of the lamps 24. The first balance transformers 31 may also be connected in series and connected to their respective lamps 24, as shown in FIG. 4. The lamps 24 may also be respectively grounded, as shown in FIG. 6, and one of the lamps 24 is electrically connected to the feedback circuit 25. Alternatively, as shown in FIG. 7, all lamps 24 are simultaneous electrically connected to the feedback circuit 25 and simultaneously grounded. The interconnections between the balance transformers 31 are mentioned hereinabove, so detailed descriptions thereof will be omitted.

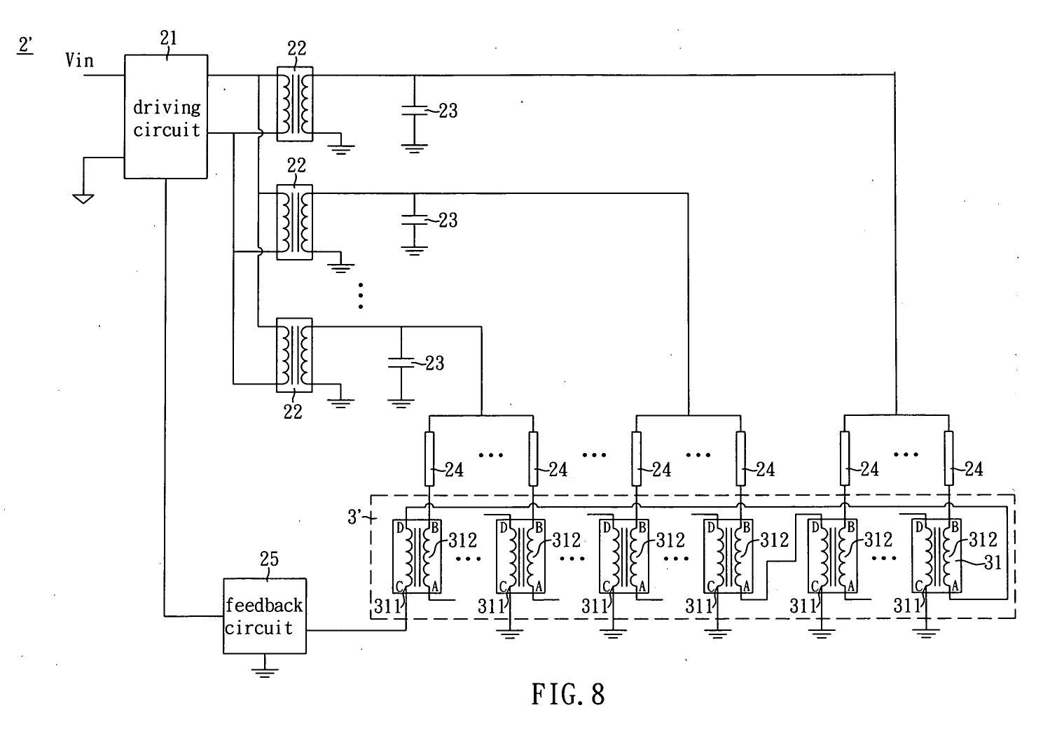

As shown in FIG. 8, the difference from FIG. 6 is that the second terminal B of each first balance transformer 31 is electrically connected to the power source Min through the driving circuit 21, the main transformer 22 and the lamp 24. In the current balance circuit 3′, the third terminal C of one of the first balance transformers 31 is electrically connected to the feedback circuit 25 so that the lamps 24 may be controlled in a feedback manner. The third terminals C of other first balance transformers 31 are individually connected to the grounding power source or grounded. In addition, the third terminals C of the first balance transformers 31 may also be commonly electrically connected with the feedback circuit 25 and then grounded (not shown in figure).

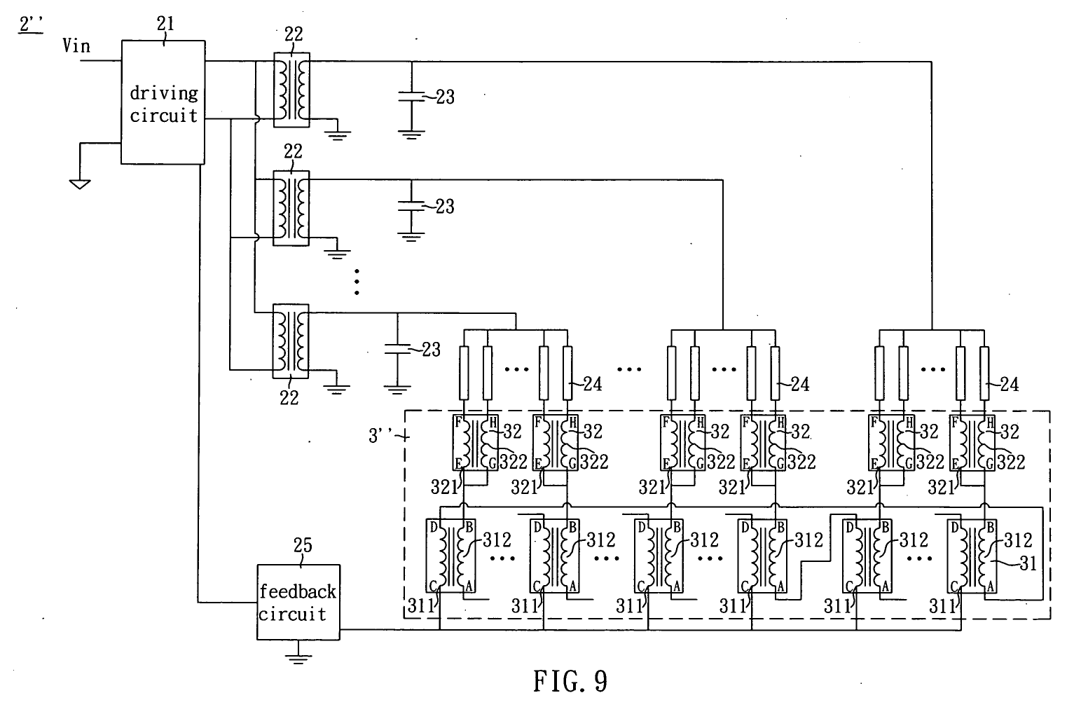

Referring to FIG. 9, a current balance circuit 3″ of another driving system 2″, in addition to a plurality of first balance transformers 31 further comprises a plurality of second balance transformers 32. The second balance transformers 32 are electrically connected to the first balance transformers 31, respectively. Each second balance transformer 32 is electrically connected to the first balance transformers 31 and the lamps 24. The third terminals C of the first balance transformers 31 are simultaneous electrically connected to the feedback circuit 25 and grounded.

Each second balance transformer 32 has a primary winding 321 and a secondary winding 322. The primary winding 321 has a fifth terminal E and a sixth terminal F. The secondary winding 322 has a seventh terminal G and an eighth terminal H. The fifth terminal E and the seventh terminal G are electrically connected to the second terminal B of the corresponding first balance transformer 31.

The sixth terminal F and the eighth terminal H of each second balance transformer 32 are electrically connected to lamps 24 so as to balance the currents flowing through two lamps. In addition, the lamps 24 are electrically connected to the main transformers 22 and the voltage stable capacitors 23. The main transformers 22 are electrically connected to the driving circuit 21 in order to electrically connect to the power source Vin.

In this embodiment, the currents flowing through every two lamps 24 are balanced by the second balance transformer 32, and the balanced currents are then balanced by the first balance transformers 31 connected in series. Because the current of each lamp 24 is balanced three times, the overall current balance effect and the current balance of each lamp 24 can be enhanced.

In this embodiment, the current balance circuit 3″ can enhance the circuit reliability of the overall driving system 2″ and enhance the balance of the current for driving each lamp. In addition, the first balance transformers 31 connected in series in the current balance circuit 3″ have a reduced demand on the coupling property of the coils. Thus, the precision requirements of the balance transformer are reduced, and the corresponding manufacturing cost of the balance transformer can be reduced.

In addition, the lamps may be respectively grounded or simultaneously grounded, the number of lamps driven by the main transformer is not restricted to two, and the number of main transformers may also be increased to enhance the driving ability when the number of lamps increases. In order to enhance the current balance effect, an additional balance transformer may balance the currents flowing through every two lamps.

Regardless of the type of the driving system, the current balance circuit can balance the currents flowing through the lamps, which are connected and grounded in various manners, and the current balance circuit and the lamps can be disposed in response to various backlight modules.

In summary, the current balance circuit for the cold cathode fluorescent lamps according to the invention has the above disclosed serially connected balance transformers. Compared with the prior art, the invention enables the driving current for the lamp to flow through at least two balance transformers so as to increase the number of times the driving current flows through the balance transformer and thus to enhance the current balance effect.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A current balance circuit for balancing currents flowing through a plurality of lamps, the current balance circuit comprising:
a plurality of first balance transformers electrically connected to the lamps, respectively, and connected in series.

2. The circuit according to claim 1, wherein each of the first balance transformers comprises:
a primary winding having a first terminal and a second terminal; and
a secondary winding having a third terminal and a fourth terminal electrically connected to a first terminal of another first balance transformer.

3. The circuit according to claim 2, wherein the third terminal is electrically connected to a main transformer, and electrically connected to a power source through the main transformer.

4. The circuit according to claim 3, wherein the main transformer is electrically connected to a driving circuit, and the third terminal is electrically connected to the power source through the main transformer and the driving circuit.

5. The circuit according to claim 2, wherein the third terminal is electrically connected to a voltage stable capacitor.

6. The circuit according to claim 2, wherein the third terminal is grounded.

7. The circuit according to claim 2, wherein the second terminal is electrically connected to one of the lamps.

8. The circuit according to claim 7, wherein the lamps are in common grounded, or are respectively grounded.

9. The circuit according to claim 7, wherein one of the lamps is electrically connected to a feedback circuit.

10. The circuit according to claim 9, wherein the feedback circuit is electrically connected to a driving circuit.

11. The circuit according to claim 7, wherein the lamps are simultaneous electrically connected to a feedback circuit in common.

12. The circuit according to claim 11, wherein the feedback circuit is electrically connected to a driving circuit.

13. The circuit according to claim 1, wherein the lamps are cold cathode fluorescent lamps.

14. The circuit according to claim 1, further comprising a plurality of second balance transformers, wherein the second balance transformers are electrically connected to one of the first balance transformers, respectively and electrically connected between the first balance transformers and the lamps.

15. The circuit according to claim 14, wherein each of the second balance transformers comprises:
a primary winding having a fifth terminal and a sixth terminal; and
a secondary winding having a seventh terminal and an eighth terminal, wherein the fifth terminal and the seventh terminal are electrically connected to the first balance transformers.

16. The circuit according to claim 15, wherein the sixth terminals and the eighth terminals of the second balance transformers are electrically connected to the lamps, respectively.

17. The circuit according to claim 16, wherein the lamps are electrically connected to a main transformer.

18. The circuit according to claim 17, wherein the main transformer is electrically connected to a driving circuit.

19. The circuit according to claim 16, wherein the lamps are electrically connected to a voltage stable capacitor.
